(19) United States
(12) Patent Application Publication
(10) Pub. No.: US 2008/0145724 A1
(43) Pub. Date: Jun. 19, 2008

(54) Method and apparatus for generating and managing energy

(76) Inventor: David W. McCary, West Hartford, CT (US)

Correspondence Address: THE LAW OFFICES OF STEVEN MCHUGH, LLC, 46 WASHINGTON STREET, MIDDLETOWN, CT, 06457, US

(21) Appl. No.: 12/002,387

(22) Filed: Dec. 17, 2007

Related U.S. Application Data
(60) Provisional application No. 60/875,478, filed on Dec. 18, 2006.

(51) Int. Cl. H01M 8/04; H01M 8/18

(52) U.S. Cl. 429/17; 429/19

(57) ABSTRACT

A system and method for generating and managing energy is provided and includes a hydrogen storage tank which includes a first and second hydrogen tank port, the first hydrogen tank port being configured to allow a hydrogen powered device to interface with the hydrogen tank and transfer hydrogen between the hydrogen tank and the hydrogen powered device, an electrical energy generation device associated with the hydrogen storage tank via the second hydrogen tank port, the electrical energy generation device configured to receive hydrogen from the hydrogen storage tank and generate electricity from the hydrogen, a power distribution device in electrical communication with the electrical energy generation device to receive the electricity, the power distribution device being configurable to distribute the electricity in a predetermined manner and at least one power port communicated with the power distribution device, the power port being configured to interface with an electric device.

### CROSS-REFERENCE TO RELATED PATENT APPLICATIONS

The present application is related to and claims priority of U.S. Provisional Patent Application Ser. No. 60/875,478 (Attorney Docket No. NET-0002-P), entitled Method and Apparatus for Generating and Managing Energy, filed on Dec. 18, 2006 and is incorporated by reference herein in its entirety.

### FIELD OF THE INVENTION

This invention relates generally to the generation and storage of energy and more particularly to the clean generation and storage of energy using a hybrid system of clean energy generation/storage means.

### BACKGROUND OF THE INVENTION

As the world's population increases, so does the amount of energy being consumed. Unfortunately, this increased energy consumption has several undesirable consequences. One such consequence involves the type of fuel being used to generate the increased amount of energy. This is because traditional fuel resources, such as coal, oil and natural gas, are typically burned to generate the required energy. This combustion process generates pollutants that are released into the atmosphere and that have a deleterious effect on both people and the environment. For example, the combustion of fossil fuels generates greenhouse gases, such as carbon dioxide, which build up in the upper portion of the atmosphere. When sunlight is incident on the earth, these gases allow the sunlight to enter the atmosphere freely. The sunlight strikes the earths' surface where some of it is reflected back towards space as infrared radiation (i.e. heat). This infrared radiation is then absorbed and trapped by the greenhouse gases that have built up in the atmosphere, thus causing an increase in global temperatures.

Another such consequence involves the quantity of the fuel being used to generate the increased amount of energy. As mention hereinbefore, fossil fuels are typically used to generate the energy required by the majority of the world's population. However, because fossil fuels are a non-renewable energy resource with finite global reserves, once these reserves have been depleted alternative sources of energy must be found. Additionally, as these resources become more scarce the cost of locating, mining and processing these fuels increases. This is undesirable because these costs are passed onto the consumer.

### SUMMARY OF THE INVENTION

A system for generating power is provided and includes a hydrogen storage tank for containing hydrogen, wherein the hydrogen storage tank includes a first hydrogen tank port and a second hydrogen tank port, the first hydrogen tank port being configured to allow a hydrogen powered device to interface with the hydrogen tank and transfer hydrogen between the hydrogen tank and the hydrogen powered device, an electrical energy generation device associated with the hydrogen storage tank via the second hydrogen tank port, the electrical energy generation device configured to receive the hydrogen from the hydrogen storage tank and generate electricity from the hydrogen, a power distribution device in electrical communication with the electrical energy generation device to receive the electricity, the power distribution device being configurable to distribute the electricity in a predetermined manner and at least one power port communicated with the power distribution device, wherein the power port is configured to interface with an electric device.

A method for generating and managing energy via a system for generating power from hydrogen is provided, wherein the method includes obtaining hydrogen from a hydrogen source, converting the hydrogen into electrical energy and distributing the electrical energy as desired.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 is a schematic diagram depicting an energy generation/storage system in accordance with a first embodiment of the present invention;

FIG. 2 is a schematic diagram depicting an energy generation/storage system in accordance with a second embodiment of the present invention;

FIG. 3 is a schematic diagram depicting an energy generation/storage system in accordance with a third embodiment of the present invention;

FIG. 4 is a schematic diagram depicting an energy generation/storage system in accordance with a fourth embodiment of the present invention; and

FIG. 5 is a block diagram illustrating a method for generating and managing power in accordance with the present invention.

### DETAILED DESCRIPTION

As disclosed herein an environmentally friendly and economical method and apparatus for producing, storing and managing the energy needs of a consumer is provided in accordance with the present invention. As such, the present invention allows a consumer the ability to take control of all of his/her energy needs (such as heating, hot water, air conditioning, electricity and/or automobile fuel) using one common fuel source, hydrogen. As a brief background, when combined with fuel cells, hydrogen can be used to fuel almost all power consumption devices/systems currently in use by consumers, including but not limited to heating means, hot water producing means, air conditioning means, electrical devices and/or hydrogen operated vehicles (automobiles, boats, motorcycles, etc). In accordance with the present invention, several embodiments of a method and apparatus for a home owner to cleanly and efficiently generate, store and distribute their own power is provided. However, these embodiments are not meant to be limiting and as such, other embodiments not explicitly disclosed herein are contemplated as being within the scope of the present invention.

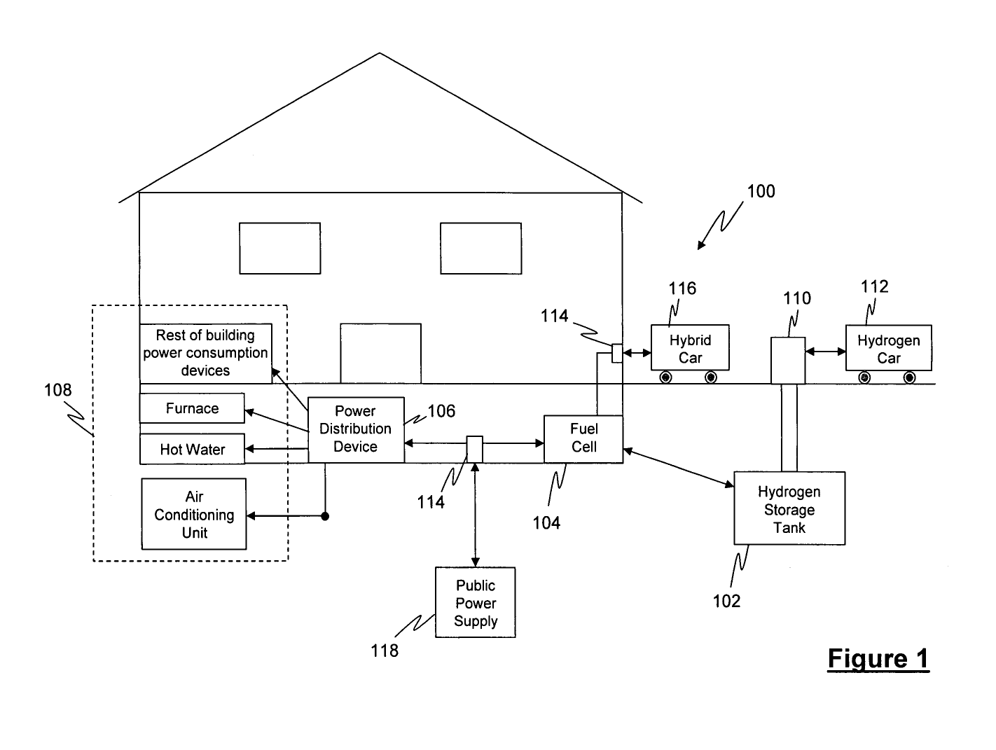

Referring to FIG. 1, a first embodiment of an energy generation and storage system 100 is illustrated and includes a hydrogen storage tank 102 and a power generation device 104 (such as an electrochemical fuel cell) associated with a power distribution device 106 for distributing power generated by power generation device 104 to a plurality of power consuming devices 108. The hydrogen storage tank 102 is associated with the power generation device 104 to allow hydrogen to be transferred between the hydrogen storage tank 102 and the power generation device 104. In this embodiment, hydrogen is transferred from the hydrogen storage tank 102 to the power generation device 104 via a hydrogen tank transfer port, wherein the power generation device 104 converts the hydrogen into electrical energy which is then transferred to the power distribution device 106 for controlled distribution to the plurality of power consuming devices 108 connected to the system 100. This allows for the efficient management of the power distribution of the system 100.

For example, if the power generation device 104 is not functioning or otherwise inoperable, the power distribution device 106 could draw power from a public power supply 118. Alternatively, if the power generation device 104 is functioning at a reduced capacity or if more power is needed than the power generation device 104 can supply, the power distribution device 106 could controllably and switchingly or consistently draw power from both the public power supply 118 and the power generation device 104. Furthermore, if the system 100 is generating more power than is being used, or if desired, then the power distribution device 106 may direct the excess energy to the public power supply 118 for sale to the public utilities.

It should be appreciated that the power generation device 104 may convert hydrogen into electrical energy via any method suitable to the desired end purpose as is known in the industry. It should also be appreciated that the hydrogen storage tank may include a fuel inlet/outlet port 110 for receiving hydrogen from an outside source, such as a commercial hydrogen dealer and for delivering hydrogen to an outside source, such as a hydrogen vehicle 112. It is contemplated that the fuel inlet/outlet port 110 can also be used to deliver unused quantities of hydrogen to an outside source for sale. Furthermore, it should be appreciated that the power generation device 104 and/or the power distribution device 106 may include an electrical power inlet/outlet port 114 for delivering power to an outside source, such as a hybrid vehicle 116. It is also appreciated that, as discussed briefly hereinbefore, the electrical power inlet/outlet port 114 may be used to receive electrical power from an outside power source (or deliver electrical power to an outside power source for sale), such as the public power supply 118.

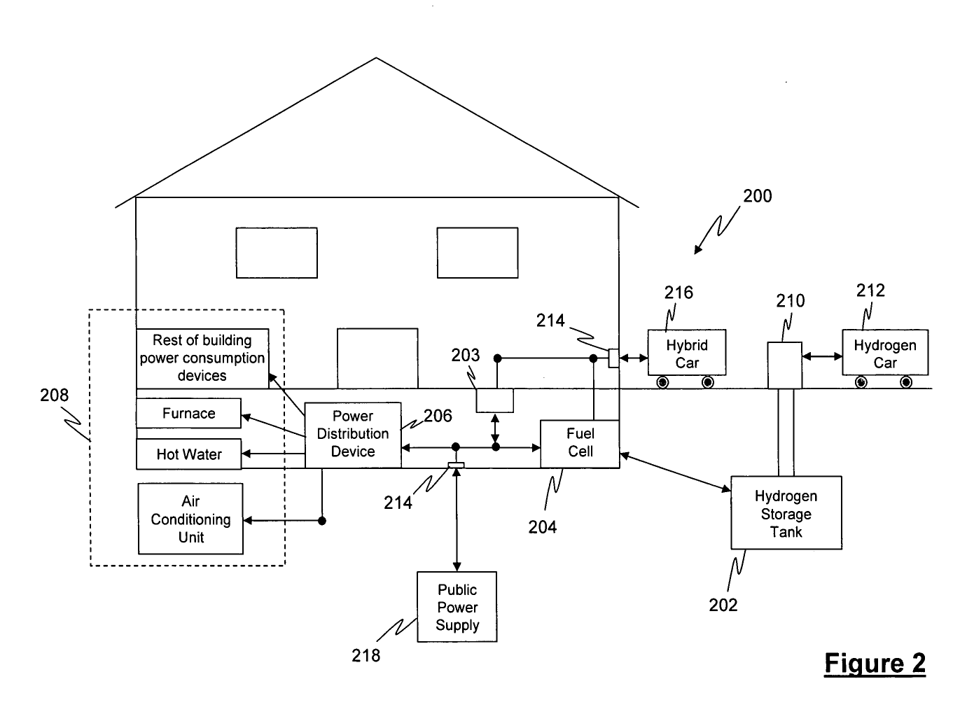

Referring to FIG. 2, a second embodiment of an energy generation and storage system 200 is illustrated and includes a hydrogen storage tank 202 and a power generation device 204 (such as an electrochemical fuel cell) associated with an energy storage device 203 (or battery cell) and a power distribution device 206 for controllably distributing power generated by the power generation device 204 to a plurality of power consuming devices 208. The hydrogen storage tank 202 is associated with the power generation device 204 to allow hydrogen to be transferred between the hydrogen storage tank 202 and the power generation device 204. In this embodiment, hydrogen is transferred from the hydrogen storage tank 202 to the power generation device 204, wherein the power generation device 204 converts the hydrogen into electrical energy which may then be transferred to the energy storage device 203 and/or the power distribution device 206 for a controlled distribution to the plurality of power consuming devices 208 connected to the system 200. This allows for the efficient management of the power distribution of the system 200.

In accordance with the present invention, the energy storage device 203 is associated with at least one of the energy storage device 203, the power generation device 204 and/or the public power supply 218, wherein the energy storage device 203 may receive and store energy from the power generation device 204. The energy storage device 203, the power generation device 204 and/or the public power supply 218 may also be associated with the power distribution device 206 to allow power from some, or all, of the energy storage device 203, the power generation device 204 and/or the public power supply 218 to be controllably distributed to power consuming devices 208.

For example, if the power generation device 204 is not functioning or otherwise inoperable, the power distribution device 206 could draw power from the public power supply 218 and/or the energy storage device 203. Alternatively, if the power generation device 204 is functioning at a reduced capacity or if more power is needed than the power generation device 204 can supply, the power distribution device 206 could controllably and switchingly or consistently draw power from the public power supply 218, the energy storage device 203 and/or the power generation device 204. Furthermore, if the system 200 is generating more power than is being used, or if desired, then the power distribution device 206 may direct the excess energy to the public power supply 218 for sale to the public utilities.

It should be appreciated that the power generation device 204 may convert hydrogen into electrical energy via any method suitable to the desired end purpose as is known in the industry. It should also be appreciated that the hydrogen storage tank 202 may include a fuel inlet/outlet port 210 for receiving hydrogen from an outside source, such as a commercial hydrogen dealer and/or for delivering hydrogen to an outside source, such as a hydrogen vehicle 212. It is contemplated that the fuel inlet/outlet port 210 can also be used to deliver unused quantities of hydrogen to an outside source for sale. Furthermore, it should be appreciated that the power generation device 204, energy storage device 203 and/or the power distribution device 206 may include an electrical power inlet/outlet port 214 for delivering power to an outside source, such as a hybrid vehicle 216. It is also appreciated that, as discussed briefly hereinbefore, the electrical power inlet/outlet port 214 may be used to receive electrical power from an outside power source (or deliver electrical power to an outside power source for sale), such as the public power supply 218.

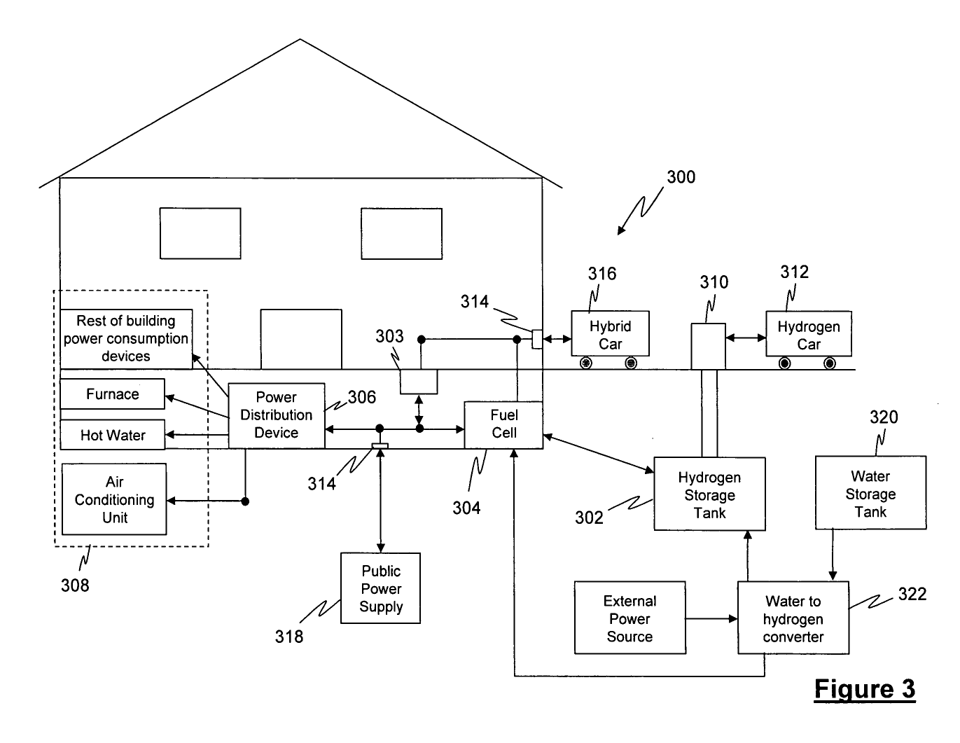

Referring to FIG. 3, a third embodiment of an energy generation and storage system 300 is illustrated and includes a hydrogen storage tank 302 and a power generation device 304 (such as an electrochemical fuel cell) associated with an energy storage device 303 and a power distribution device 306 for controllably distributing power generated by the power generation device 304 to a plurality of power consuming devices 308. The hydrogen storage tank 302 is associated with the power generation device 304 to allow hydrogen to be transferred between the hydrogen storage tank 302 and the power generation device 304. The energy generation and storage system 300 may also include a water (or other substance containing recoverable hydrogen) storage tank 320 associated with a hydrogen conversion/recovery device 322 (such as a water cracking device as is known in the art) for converting/recovering hydrogen from the water. The hydrogen conversion/recovery device 322 is further associated with the hydrogen storage tank 303, wherein hydrogen converted/recovered by the hydrogen conversion/recovery device 322 is transferred to the hydrogen storage tank 303 for future use and/or sale.

In this embodiment, hydrogen may be delivered and/or stored in the hydrogen storage tank 302 and/or hydrogen may be generated using the hydrogen conversion/recovery device 322. To accomplish this, a hydrogen source (such as water) may be stored in water storage tank 320 and/or called on demand from a well and/or public water supply and supplied to the hydrogen conversion/recovery device 322 which may be powered via an external power source (such as public power supply 318 or other device), a battery device and/or the system 300 itself. The hydrogen conversion/recovery device 322 generates hydrogen (“cracks”) from the water and transfers the hydrogen to the hydrogen storage tank 302. It is also contemplated that the hydrogen may be generated on demand and introduced directly into the system 300.

The hydrogen may then be transferred from the hydrogen storage tank 302 to the power generation device 304, wherein the power generation device 304 converts the hydrogen into electrical energy which may then be transferred to the energy storage device 303 and/or the power distribution device 306 for a controlled distribution of power to the plurality of power consuming devices 308 connected to the system 300. This allows for the efficient management of the power distribution of the system 300.

In accordance with the present invention, the energy storage device 303 is associated with at least one of the energy storage device 303, the power generation device 304 and/or the public power supply 318, wherein the energy storage device 303 may receive and store energy from the power generation device 304. The energy storage device 303, the power generation device 304 and/or the public power supply 318 may also be associated with the power distribution device 306 to allow power from some, or all, of the energy storage device 303, the power generation device 304 and/or the public power supply 318 to be controllably distributed to power consuming devices 308.

For example, if the power generation device 304 is not functioning or otherwise inoperable, the power distribution device 306 could draw power from the public power supply 318 and/or the energy storage device 303. Alternatively, if the power generation device 304 is functioning at a reduced capacity or if more power is needed than the power generation device 304 can supply, the power distribution device 306 could controllably and switchingly or consistently draw power from the public power supply 318, the energy storage device 303 and/or the power generation device 304. Furthermore, if the system 300 is generating more power than is being used, or if desired, then the power distribution device 306 may direct the excess energy to the public power supply 318 for sale to the public utilities.

It should be appreciated that the power generation device 304 may convert hydrogen into electrical energy via any method suitable to the desired end purpose as is known in the industry. It should also be appreciated that the hydrogen storage tank 302 may include a fuel inlet/outlet port 310 for receiving hydrogen from an outside source, such as a commercial hydrogen dealer and/or for delivering hydrogen to an outside source, such as a hydrogen vehicle 312. It is contemplated that the fuel inlet/outlet port 310 can also be used to deliver unused quantities of hydrogen to an outside source for sale. Furthermore, it should be appreciated that the power generation device 304, energy storage device 303 and/or the power distribution device 306 may include an electrical power inlet/outlet port 314 for delivering power to an outside source, such as a hybrid vehicle 316. It is also appreciated that, as discussed briefly hereinbefore, the electrical power inlet/outlet port 314 may be used to receive electrical power from an outside power source (or deliver electrical power to an outside power source for sale), such as the public power supply 318.

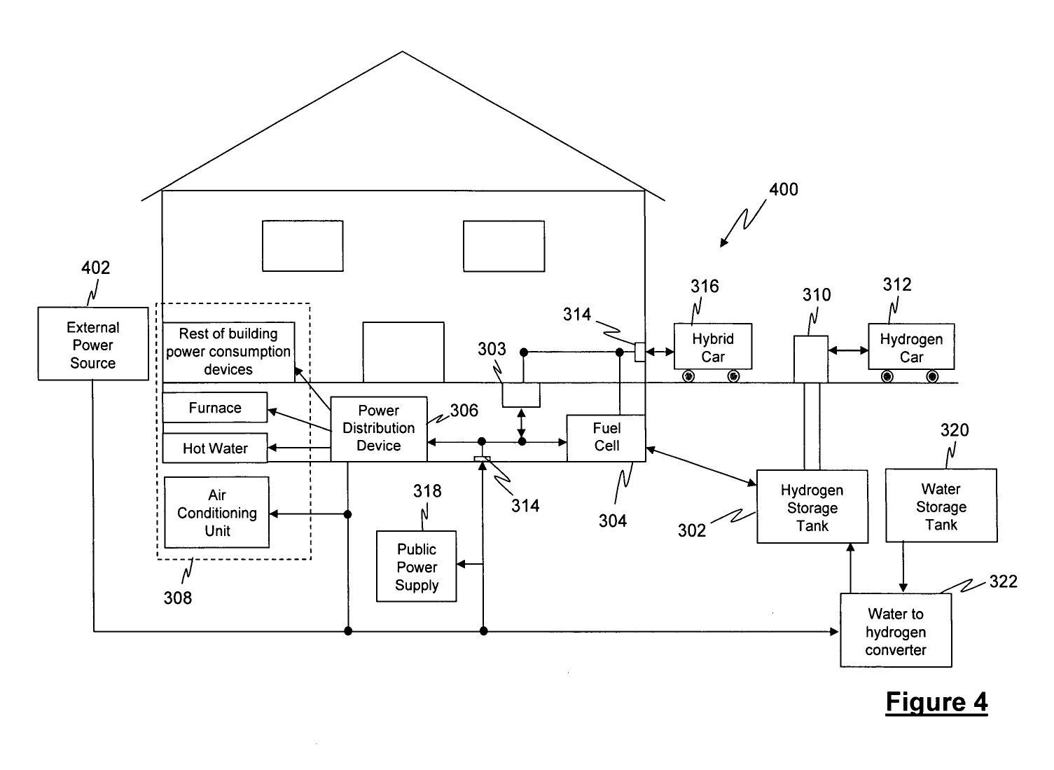

Referring to FIG. 4, a fourth embodiment of an energy generation and storage system 400 is illustrated and includes an external power source 402 that may be connected to at least one of the power distribution device 306, energy storage device 303, power generation device 304, public power supply 318 and hydrogen conversion/recovery device 322. It should be appreciated that the external power source 402 may be any type of device suitable to the desired end purpose of generating power, such as windmill for converting wind energy to electricity, a water mill for converting kinetic water power to electricity, solar panels for converting sun energy to electricity and/or a device for converting kinetic energy into electricity, such as an exercise device.

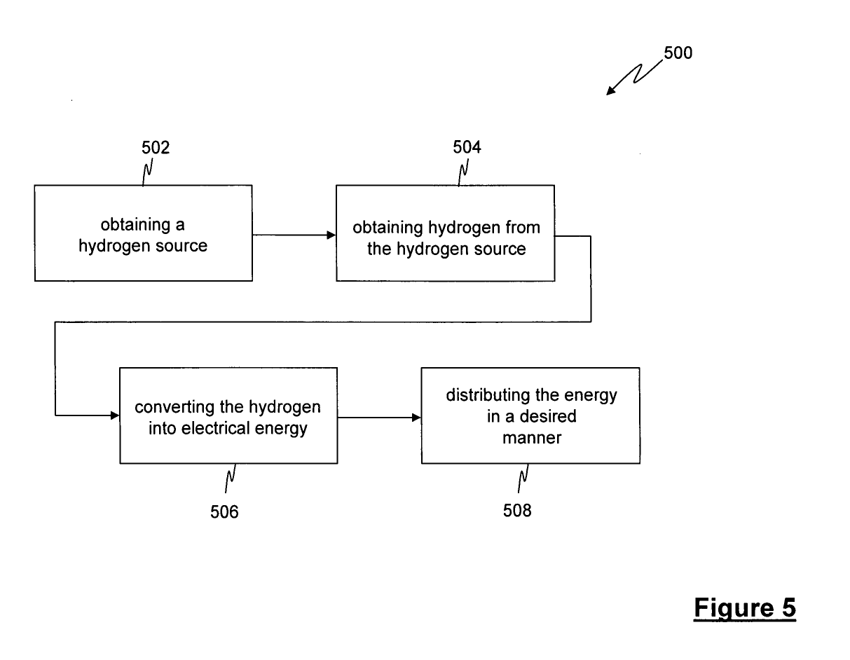

Referring to FIG. 5, a block diagram illustrating a method 500 for generating and managing energy is illustrated and includes obtaining a hydrogen source 102, 202, 302, 320, 322 as shown in operational block 502. In accordance with the present invention, the hydrogen source 102, 202, 302, 320 may be hydrogen stored in a storage tank 102, 202, 302 and/or water (or some other substance from which hydrogen can be recovered) stored in a water tank 320 or provided on demand by a well and/or a public water supply. The hydrogen is then obtained from the hydrogen source 102, 202, 302, 320, 322, as shown in operational block 504 and converted into electrical energy, as shown in operational block 506. If the hydrogen source 102, 202, 302, 320, 322 is a hydrogen tank 102, 202, 302, then this may be accomplished by transferring the hydrogen stored in the hydrogen tank 102, 202, 302 to a power generation device 102, 202, 302 or fuel cell which converts the hydrogen into electrical energy. On the other hand, if the hydrogen source is water (or some other substance from which hydrogen can be recovered) then the water is introduced into a hydrogen conversion/recovery device 322 or “water cracker” which recovers the hydrogen from the water. The recovered hydrogen may then be transferred to the power generation device 102, 202, 302 or fuel cell for conversion into electrical energy. Once the electrical energy has been generated, the electrical energy may be distributed as desired, as shown in operational block 508. Accordingly, the electrical energy may be distributed to the power consuming devices 108, 208, 308, 316, 322 for consumption, the battery for storage and future use and/or sale and/or to the public power supply 318 for sale.

It should be appreciated that the power distribution device 106, 206 and 306 of the energy generation and storage system 100, 200, 300, 400 may include a processing device and/or logic to control distribution of power, to monitor the elements of the system 100, 200, 300, 400 and/or to determine how power should be distributed. This would allow the energy generation and storage system 100, 200, 300, 400 to sense whether there is enough power in the system to sell back to the utilities, that more hydrogen needs to be obtained and/or whether any of the elements of the system 100, 200, 300, 400 require repair and/or maintenance. Additionally, it should be appreciated that the energy generation and storage system 100, 200, 300, 400 may include a hydrogen outlet configured to distribute hydrogen to hand-held or small hydrogen powered devices, such as PDA's, cell phones and lighters.

It should also be appreciated that the present invention may be applied to communities as well as individual consumers. For example, a neighborhood in a residential area may pool their resources to form a ‘local’ power company to satisfy their energy needs. Additionally, any ‘extra’ electricity or hydrogen produced may be sold to power companies or hydrogen supply companies. It is contemplated that the electricity and/or the hydrogen produced by the generation/storage systems 100, 200, 300, 400 may be used to fuel/operate any devices suitable to the desired end purpose, such as hot water heater, a hybrid vehicle (both electric and hydrogen operated), an air conditioning system, kitchen appliances, furnaces, televisions, stereos, water pumps, lights, etc. Accordingly, the electricity consuming devices may draw electricity by interfacing with the power distribution system 106, 206, 306, the fuel cell 104, 204, 304 and/or the battery 203, 303 via at least one power distribution port.

A machine-readable computer program code and/or a medium encoded with a machine-readable computer program code for implementing all or some of the method 500 of the invention, the code and/or medium including instructions for causing a controller to implement a method for generating and managing energy is provided. In accordance with an exemplary embodiment, the processing of the present invention may be implemented by a controller disposed internal, external or internally and externally to the Web server. In addition, processing of the present invention may be implemented through a controller operating in response to a computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

Additionally, all or some of the method 500 of the invention may be embodied in the form of a computer or controller implemented processes. Furthermore, all or some of the method 500 of the invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The method 500 of the invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A system for generating power, the system comprising:
a hydrogen storage tank for containing hydrogen, wherein said hydrogen storage tank includes a first hydrogen tank port and a second hydrogen tank port, said first hydrogen tank port being configured to allow a hydrogen powered device to interface with said hydrogen tank and transfer hydrogen between said hydrogen tank and said hydrogen powered device;
an electrical energy generation device associated with said hydrogen storage tank via said second hydrogen tank port, said electrical energy generation device configured to receive said hydrogen from said hydrogen storage tank and generate electricity from said hydrogen;
a power distribution device in electrical communication with said electrical energy generation device to receive said electricity, said power distribution device being configurable to distribute said electricity in a predetermined manner; and
at least one power port communicated with said power distribution device, wherein said power port is configured to interface with an electric device.

2. The system of claim 1, further comprising an energy storage device communicated with at least one of said power distribution device and said electrical energy generation device to receive and store said electricity.

3. The system of claim 2, wherein said energy storage device is a battery.

4. The system of claim 1, further comprising a hydrogen conversion/recovery device, wherein said hydrogen storage tank is in flow communication with said hydrogen conversion/recovery device such that said hydrogen storage tank receives and stores hydrogen converted/recovered by said hydrogen conversion/recovery device.

5. The system of claim 4, further comprising a water storage tank for storing water, wherein said water storage tank is in flow communication with said hydrogen conversion/recovery device to allow water to flow between said water storage tank and said hydrogen conversion/recovery device.

6. The system of claim 1, wherein said electrical energy generation device is an electrochemical fuel cell.

7. The system of claim 1, further comprising an external power source in electrical communication with at least one of a hydrogen conversion/recovery device, said power distribution device, said energy storage device and said public power supply.

8. The system of claim 7, wherein said external power source is at least one of a public power supply, a wind-to-electricity conversion device, a water-to-electricity conversion device, a solar energy conversion device and a kinetic energy conversion device.

9. The system of claim 1, wherein said power distribution device includes a processing device for controlling the distribution of said electricity throughout the system.

10. The system of claim 1, further comprising a plurality of electricity consuming devices in communication with said power distribution device via at least one power distribution port.

11. The system of claim 10, wherein said plurality of electricity consuming devices includes at least one of a furnace, a hot water heater, an air conditioning unit and a hybrid vehicle.

12. The system of claim 1, wherein said hydrogen storage tank includes a fuel inlet/outlet port configured to interface with a vehicle containing hydrogen to allow hydrogen to flow between said hydrogen storage tank and said vehicle containing hydrogen.

13. A method for generating and managing energy via a system for generating power from hydrogen, the method comprising:
obtaining hydrogen from a hydrogen source;
converting said hydrogen into electrical energy; and
distributing the electrical energy as desired.

14. The method of claim 13, wherein said obtaining includes at least one of
storing said hydrogen in a refillable hydrogen storage tank, and
recovering said hydrogen from a replenishable hydrogen source.

15. The method of claim 14, wherein said replenishable hydrogen source is water.

16. The method of claim 14, wherein said recovering includes processing said water via a hydrogen conversion/recovery device to separate said hydrogen from said water.

17. The method of claim 13, wherein said converting said hydrogen into electrical energy includes
introducing said hydrogen into an electrical energy generation device configured to convert said hydrogen into said electricity.

18. The method of claim 17, wherein said electrical energy generation device is an electrochemical fuel cell configured to convert said hydrogen into said electricity via an electrochemical process.

19. The method of claim 13, wherein said distributing includes receiving said electrical energy and storing said electrical energy in an energy storage device.

20. The method of claim 13, wherein said distributing includes controlling the distribution of electrical energy within the system for generating power from hydrogen.
